(19) United States
(12) Patent Application Publication
(10) Pub. No.: US 2024/0417025 A1
(43) Pub. Date: Dec. 19, 2024

(54) BUCKLE-TYPE QUICK RELEASE WITH BIDIRECTIONAL LENGTH ADJUSTABILITY

(71) Applicant: FUL CHEE ENT CO., LTD., Taichung City (TW)

(72) Inventor: Yu-Chen Liu, Taichung City (TW)

(21) Appl. No.: 18/227,964

(22) Filed: Jul. 30, 2023

(30) Foreign Application Priority Data
Jun. 13, 2023 (TW) 112121945

(51) Int. Cl. B62K 25/02

(52) U.S. Cl. CPC B62K 25/02; B62K 2206/00

(57) ABSTRACT

A buckle-type quick release with bidirectional length adjustability includes a shaft, defining an axial hole that has a wall formed with a first-end internally threaded segment and a second-end internally threaded segment; an adjusting bolt, having an external threaded segment that is made to be screwedly engaged with the first-end internally threaded segment of the axial hole; a movable sleeve, defining therein a channel made to receive a ringlike spring and is made to be mounted around the shaft; and an eccentric screwing component, having an eccentrically rotatable quick-release lever and a screwing rod formed with an external threaded segment, so that the external threaded segment of the screwing rod after passing through the movable sleeve and the ringlike spring can be screwedly engaged with the second-end internally threaded segment of the axial hole. The quick release has its length adjustable in two opposite directions and has improved usability.

### BACKGROUND OF THE PRESENT INVENTION

### Field of Invention

The present invention relates to a quick release, and more particularly to a buckle-type quick release that has its length adjustable in two opposite directions and thus has improved usability.

### Description of Related Arts

A conventional bicycle buckle-type quick release 10, as shown in FIG. 1 and FIG. 2, comprises: a shaft 11, which is a hollow round bar defining therein an axial hole 12, and has one end provide with an eccentric screwing component 13; an inner sleeve 14, having one end formed with an extension segment 141 and having an inner wall formed with internal threads 142; an adjusting bolt 15 formed with external threads 151 and having one end provided with a plug head 152 to be clamped by an external tool and an opposite end formed with an annular groove 153, wherein the adjusting bolt 15, at the end having the annular groove 153, is such screwed into the inner sleeve 14 through the extension segment 141 that it protrudes out of an opposite end of the inner sleeve 14; and a stop clip 154, fit in the annular groove 153 to retain the adjusting bolt 15 from being over-screwed with respect to the inner sleeve 14 and to hold the inner sleeve 14 inside the axial hole 12 with the extension segment 141 protruding out of the axial hole 12. To work with the quick release 10, a clamping component 16 is provide at the outer side of a bicycle frame 1. The clamping component 16 contains therein a movable mouth 17 that can open and close under springiness and is shaped like a camera shutter. After the plug head 152 pushes the movable mouth 17 open and passes therethrough, the movable mouth 17 restores it close state under springiness to hold the adjusting bolt 15 in position. Then the eccentric screwing component 13 press the bicycle frame 1 and the shaft 11 against each other. Such a structure not only serves to fasten the wheel set to the bicycle frame 1, but also provides length adjustability to remedy width errors caused by manufacturing inaccuracy or impact undergone by the bicycle frame 1 or to adapt the quick release to bicycle frame different in width. The adjustability is implemented by rotation of the adjusting bolt 15 that slightly changes the length of the buckle-type quick release 10 at one end. However, the known buckle-type quick release 10 only has length adjustability at one end, and only accommodates moderate adjustment or the shaft 11 would be excessively remote from one side. These limitations limit the overall adjustment range and prevent the known device from being adaptive to various bicycle frames different in width. Hence, there is a need for improvements.

### SUMMARY OF THE PRESENT INVENTION

The primary objective of the present invention is to address the foregoing issues by providing a buckle-type quick release with bidirectional length adjustability. In particular, an adjusting bolt having plug head and a screwing rod are adjustably screwed into two ends of the fast-assembling buckle-type quick release, respectively, so that the length of the quick release can be adjusted at two ends, or in two directions, with doubled adjustment capacity by simply rotating the adjusting bolt and/or the screwing rod, thereby providing improved usability as compared to existing devices.

To achieve the objective of the present invention, the buckle-type quick release with bidirectional length adjustability comprises: a shaft, defining an axial hole that passes therethrough wherein the axial hole has a wall formed with a first-end internally threaded segment at one end of the shaft and a second-end internally threaded segment at an opposite end of the shaft; an adjusting bolt, having an external threaded segment and being provided at one end with a plug head, wherein the external threaded segment of the adjusting bolt is made to be screwedly engaged with the first-end internally threaded segment of the axial hole; a movable sleeve, defining therein a channel, and having one end thereof formed with an opening and an opposite end formed with a through hole communicated with the channel, wherein, during fabrication, a ringlike spring is placed into the channel, and then the movable sleeve is mounted around the end of the shaft away from the adjusting bolt through the opening, such that the ringlike spring has one end abutting against the shaft and an opposite end abutting against the movable sleeve; and an eccentric screwing component, having a quick-release lever that is eccentrically rotatable and a screwing rod, wherein the screwing rod has a periphery formed with an external threaded segment, such that, during fabrication, the external threaded segment of the screwing rod passes through the through hole of the movable sleeve and the ringlike spring before being screwed into the second-end internally threaded segment of the axial hole.

In one embodiment of the present invention, a tightening torque between the first-end internally threaded segment and the adjusting bolt is greater than a tightening torque between the second-end internally threaded segment and the screwing rod.

In one embodiment of the present invention, the external threaded segment of the adjusting bolt is coated with a Nylok coating.

In one embodiment of the present invention, the screwing rod has the periphery further formed with a slide segment relatively close to the eccentric screwing component and a retaining flange that is located between the external threaded segment of the screwing rod and the slide segment, and the shaft has a periphery formed with at least one side via that positionally corresponds to the slide segment and is communicated with the axial hole, in which the side via receives a retaining pin that protrudes out of the axial hole, and the retaining flange can be screwedly displacement to abut against an edge of the retaining pin.

In one embodiment of the present invention, the retaining pin is a countersunk screw, and the side via is a threaded hole defined by a wall that is formed with internal threads.

In one embodiment of the present invention, the plug head is provided with a head socket that is open outward.

In one embodiment of the present invention, the shaft has an end flange formed at the end where the second-end internally threaded segment is formed, and the channel has an inner diameter that is larger than an inner diameter of the through hole, such that a ledge is formed between the channel and the through hole and the ringlike spring has one end abutting against the end flange and an opposite end abutting against the ledge.

With the aforementioned configuration, the disclosed buckle-type quick release has its length adjustable in two opposite directions and thus has improved usability.

### BRIEF DESCRIPTION OF THE DRAWINGS

FIG. 1 is a partially exploded view of a conventional device;

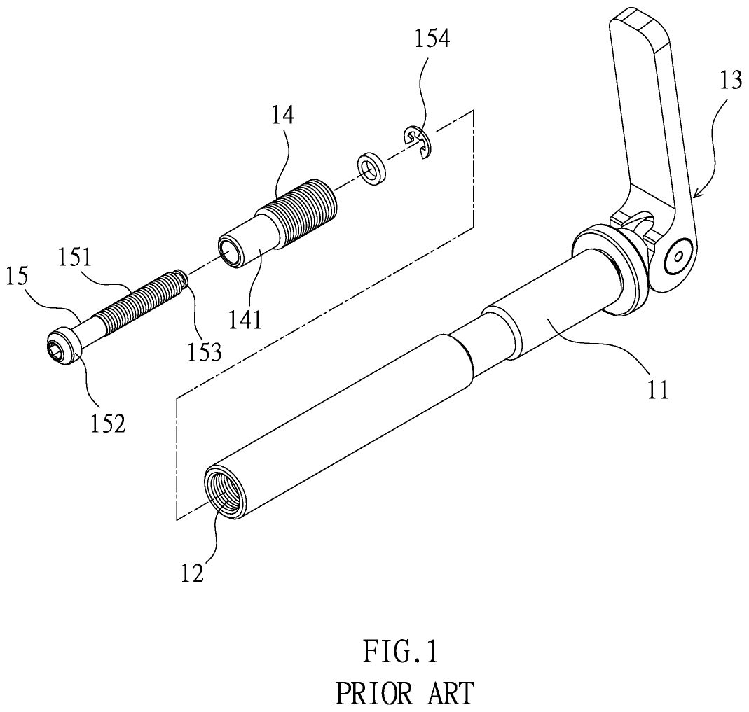

FIG. 2 is a lateral cross-sectional view of the conventional device assembled to a bicycle frame;

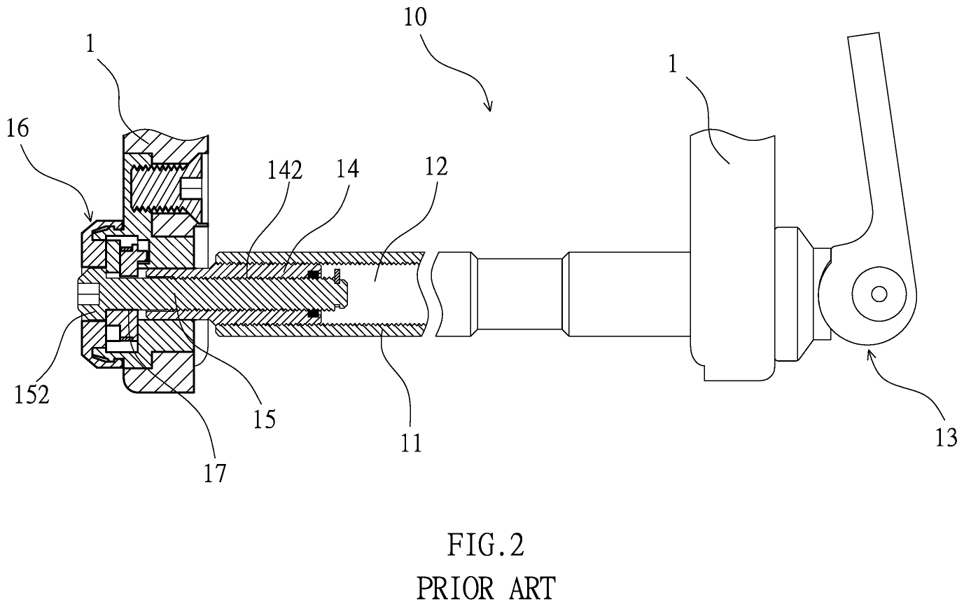

FIG. 3 is an exploded view of a buckle-type quick release of the present invention;

FIG. 4 is a perspective view of the buckle-type quick release of the present invention;

FIG. 5 is a lateral cross-sectional view of the buckle-type quick release of the present invention;

FIG. 6 is an applied, cross-sectional view showing the buckle-type quick release of the present invention during length adjustment at one end thereof;

FIG. 7, similar to FIG. 6, shows the buckle-type quick release of the present invention during length adjustment at an opposite end thereof; and

FIG. 8 is a partial, cross-sectional view of the buckle-type quick release of the present invention showing its Nylok-coated adjusting bolt.

### DETAILED DESCRIPTION OF THE PREFERRED EMBODIMENT

The following description, in conjunction with the accompanying drawings and preferred embodiments, is set forth as below to illustrate the present invention in detail.

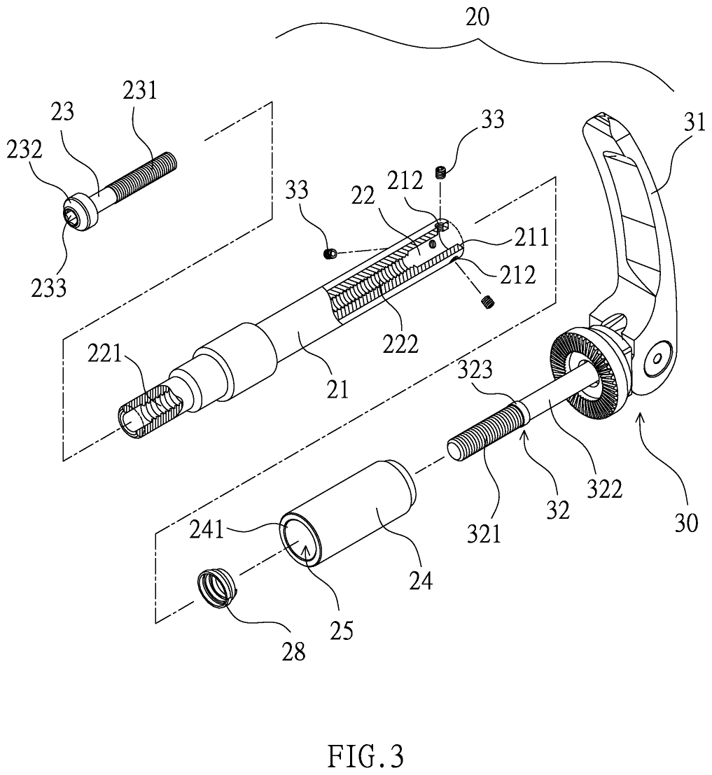

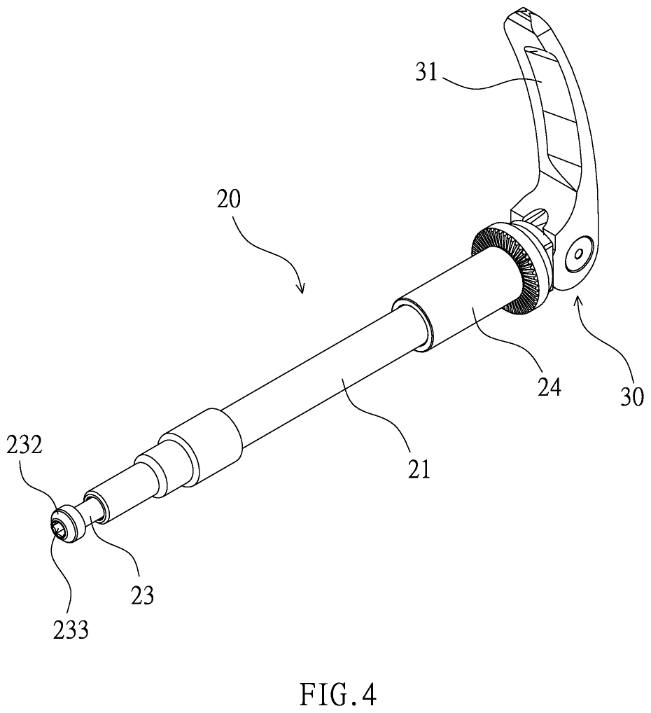

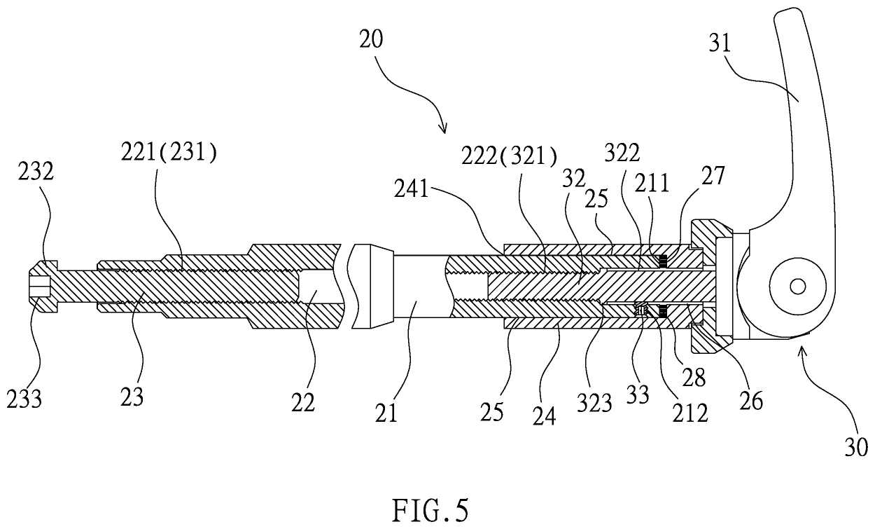

Referring to FIG. 3 through FIG. 7, a buckle-type quick release 20 comprises: a shaft 21, which is a hollow round bar, and defines therein an axial hole 22, wherein the axial hole 22 has a wall formed with a first-end internally threaded segment 211 at one end of the shaft 21 and a second-end internally threaded segment 222 at an opposite end of the shaft 21, and the shaft 21 has an end flange 211 formed at the end where the second-end internally threaded segment 222 is formed; a adjusting bolt 23, having an external threaded segment 231 and being provided at one end with a plug head 232 that can be clamped by an external tool, wherein the plug head 232 is provided with a head socket 233 that is open outward, and the external threaded segment 231 of the adjusting bolt 23 is made to be screwedly engaged with the first-end internally threaded segment 221 of the axial hole 22; a movable sleeve 24, defining therein a channel 25, and having one end thereof formed with an opening 241 and an opposite end formed with a through hole 26 communicated with the channel 25, wherein the channel 25 has an inner diameter that is larger than an inner diameter of the through hole 26, such that a ledge 27 is formed between the channel 25 and the through hole 26, in which a ringlike spring 28 is placed into the channel 25, and then the movable sleeve 24 is mounted around the end of the shaft 21 away from the adjusting bolt 23 through the opening 241, such that the ringlike spring 28 has one end abutting against the end flange 211 of the shaft 21 and an opposite end abutting against the ledge 27 of the movable sleeve 24; and an eccentric screwing component 30, having a quick-release lever 31 that is eccentrically rotatable and a screwing rod 32 made to be screwedly engaged with the second-end internally threaded segment 222, wherein the screwing rod 32 has a periphery formed with an external threaded segment 321 relatively remote from the eccentric screwing component 30, a slide segment 322 relatively close to the eccentric screwing component 30, and a retaining flange 323 located between the external threaded segment 321 and the slide segment 322. Thereby, during fabrication, after the external threaded segment 321 of the screwing rod 32 passes through the through hole 26 of the movable sleeve 24 and the ringlike spring 28 and then screwed into the second-end internally threaded segment 222 of the axial hole 22, it compresses the ringlike spring 28. In addition, the shaft 21 has a periphery formed with at least one side via 212 that positionally corresponds to the slide segment 322 and is communicated with the axial hole 22, in which the side via 212 receives a retaining pin 33 that protrudes out of the axial hole 20, and the retaining flange 323 can be screwedly displacement to abut against an edge of the retaining pin 33, so as to limit the screwing rod 32 to slide in the range defined by the slide segment 322. With the aforementioned configuration, the buckle-type quick release 20 that has its length adjustable in two opposite directions and thus has improved usability.

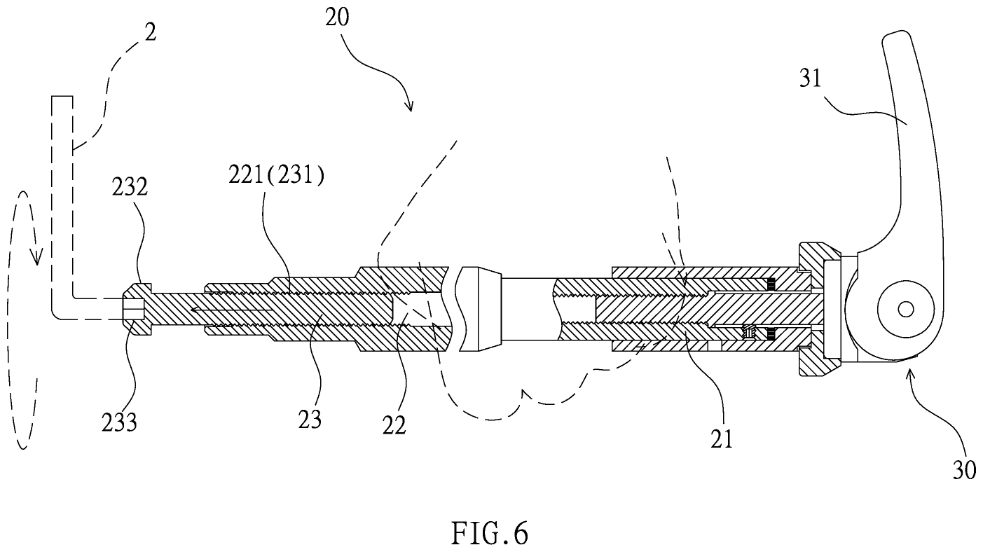

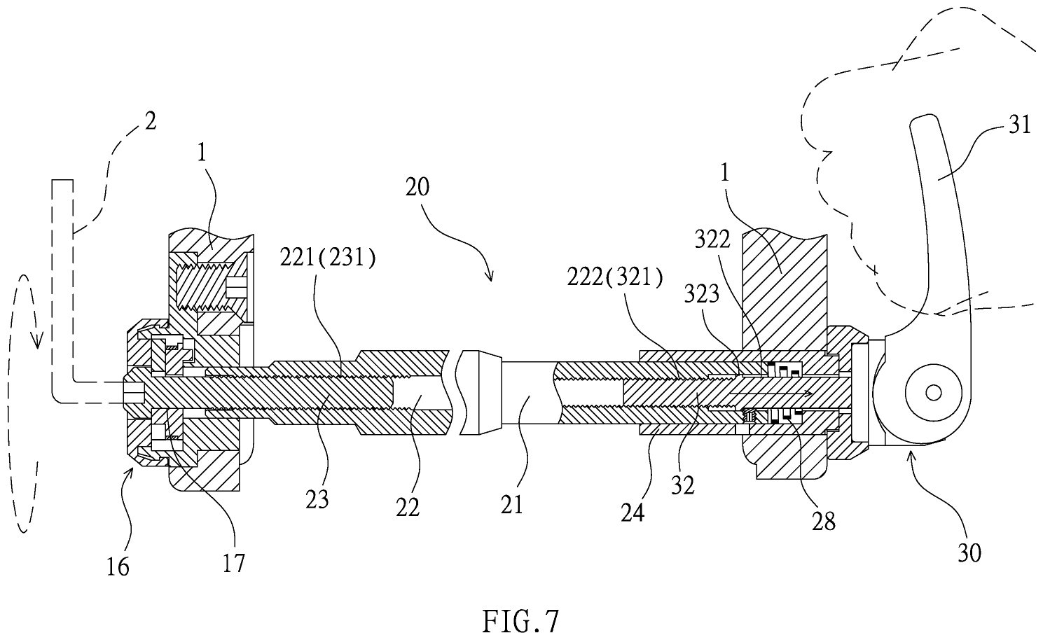

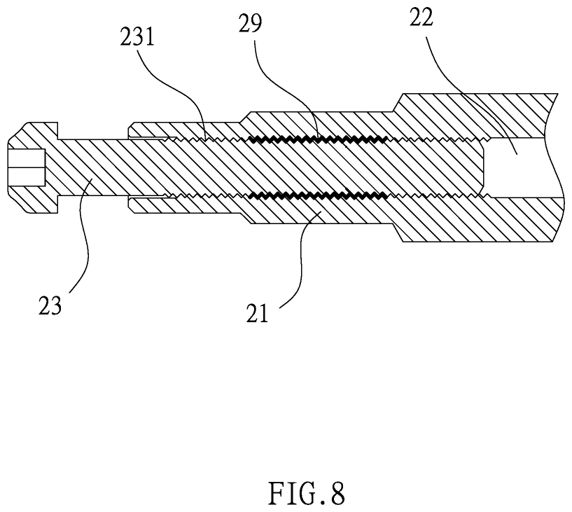

The composition, action, and effects of the present invention will be detailed below. Referring to FIG. 3 through FIG. 8, in the present embodiment, the retaining pin 33 is a countersunk screw, and the side via 212 is a threaded hole having its wall formed with internal threads. When the retaining pin 33 is screwed into the side via 212, the retaining pin 33 protrudes out of the axial hole 22 without abutting against the slide segment 322, so as not to hinder rotation of the screwing rod 32. Additionally, the retaining flange 323 prevents the screwing rod 32 from wrongly coming off the shaft 21. Moreover, in the present invention, the tightening torque between the first-end internally threaded segment 221 and the adjusting bolt 23 is greater than the tightening torque between the second-end internally threaded segment 222 and the screwing rod 32. The purpose is that, when the buckle-type quick release 20 is assembled to a bicycle frame 1, and a wrench tool 2 is engaged with the head socket 233 of the adjusting bolt 23 to implement rotation, relative rotation between the shaft 21 and the adjusting bolt 23 is prevented, while relative rotation between the shaft 21 and the screwing rod 32 is activated. In other words, when the adjusting bolt 23 is driven by a wrench tool 2, its rotation displaces the screwed engagement of the screwing rod 32 and in turn changes the working length of the buckle-type quick release 20. Referring to FIG. 8, in the present embodiment, setting of the tightening torque is enabled by use of a Nylok coating 29 provided around the external threaded segment 231 of the adjusting bolt 23. By designing where and how thick the Nylok coating 29 is applied, a desired value of the tightening torque and a desired friction capacity of the adjusting bolt 23 can be set to prevent looseness or falling off and to provide water seal. To adjust the length of the buckle-type quick release 20, a user may first hold the shaft 21 with one hand, and fit a wrench tool 2 into the head socket 233 of the adjusting bolt 23. Then the user can rotate the adjusting bolt 23 to rotate it with respect to the shaft 21 (as shown in FIG. 6). By rotating the adjusting bolt 23 clockwise, the adjusting bolt 23 is screwed into the first-end internally threaded segment 221, so as to shorten the buckle-type quick release 20. By rotating the adjusting bolt 23 anticlockwise, the adjusting bolt 23 is screwed out the first-end internally threaded segment 221, so as to lengthen the buckle-type quick release 20. In order to prevent the shaft 21 from being excessively remote to one side. Then the user may hold the quick-release lever 31 in one hand and fits a wrench tool 2 into the head socket 233 of the adjusting bolt 23. Since the external threaded segment 231 of the adjusting bolt 23 is coated with the Nylok coating 29 that increases friction, the tightening torque is increased. As a result, when the wrench tool 2 is rotated, the adjusting bolt 23 and the shaft 21 are driven to rotate synchronously, thereby causing relative rotation between the shaft 21 and the screwing rod 32 (as shown in FIG. 7). Clockwise rotation of the shaft 21 screws the screwing rod 32 into the second-end internally threaded segment 222 and thus shortens the buckle-type quick release 20 in length. As this time, the eccentric screwing component 30 presses against the movable sleeve 24 and the ringlike spring 28, so as to move the movable sleeve 24 toward the shaft 21. Anticlockwise rotation of the shaft 21 screws the screwing rod 32 out of the second-end internally threaded segment 222 and thus lengthens the buckle-type quick release 20 in length. At this time, the ringlike spring 28 restores from the compressed state in virtue of its springiness and props the movable sleeve 24 and the eccentric screwing component 30, so as to move the movable sleeve 24 away from the shaft 21, making the movable sleeve 24 and the eccentric screwing component 30 contact each other tightly without any gap therebetween. As such, the shaft 21 of the buckle-type quick release 20 can be evenly shortened or lengthened at its both ends. In use, the buckle-type quick release 20 may be set into a proper length as described previously and then assembled to a bicycle frame 1 for fastening a wheel axle. Additionally or alternatively, if mismatching in length is found between the buckle-type quick release 20 and a bicycle frame 1 it has been assembled to, a user may use a wrench tool 2 engaged with the head socket 233 of the adjusting bolt 23 to rotate the adjusting bolt 23 to allow relative rotation between the shaft 21 and the screwing rod 32, thereby making fine adjustment and adapt the buckle-type quick release 20 to the bicycle frame 1 in terms of length.

With the configuration described previously, the present invention has the following advantages:
1. The width of a bicycle frame 1 may vary depending on its brand and model, and the disclosed quick release, in virtue of the adjusting bolt 23 and the screwing rod 32, can be adjusted in length at both ends to adapt the buckle-type quick release 20 to bicycle frames of various specifications, making the quick release more usable.
2. The buckle-type quick release 20 can be easily adjust in length at either or both of its two ends by rotating the adjusting bolt 23 and/or the screwing rod 32 without replacing an alternative shaft or other components, so the adjustment is simple, convenient, and fast.
3. With the adjusting bolt 23 and the screwing rod 32, the shaft 21 can be shortened or lengthened evenly at both ends, so as to prevent unbalance when the shaft 21 is assembled to a bicycle frame 1, thereby ensuring structural stability and smooth wheel rotation of the bicycle.
4. The buckle-type quick release with length adjustability at both ends 20 has improved service life as it can be adapted to reused for another bicycle after simple adjustment in length of the shaft 21. This eliminates the need of using a new buckle-type quick release 20 for a new bicycle, and in turn reduces the costs for maintenance of bicycles.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A buckle-type quick release with bidirectional length adjustability, comprising: a shaft, defining an axial hole that passes therethrough wherein the axial hole has a wall formed with a first-end internally threaded segment at one end of the shaft and a second-end internally threaded segment at an opposite end of the shaft; an adjusting bolt, having an external threaded segment relatively remote from the eccentric screwing component and being provided at one end with a plug head, wherein the external threaded segment of the adjusting bolt is made to be screwedly engaged with the first-end internally threaded segment of the axial hole; a movable sleeve, defining therein a channel, and having one end thereof formed with an opening and an opposite end formed with a through hole communicated with the channel, wherein, during fabrication, a ringlike spring is placed into the channel, and then the movable sleeve is mounted around the end of the shaft away from the adjusting bolt through the opening, such that the ringlike spring has one end abutting against the shaft and an opposite end abutting against the movable sleeve; and an eccentric screwing component, having a quick-release lever that is eccentrically rotatable and a screwing rod, wherein the screwing rod has a periphery formed with an external threaded segment relatively remote from the eccentric screwing component, such that, during fabrication, the external threaded segment of the screwing rod passes through the through hole of the movable sleeve and the ringlike spring before being screwed into the second-end internally threaded segment of the axial hole.

2. The buckle-type quick release with bidirectional length adjustability of claim 1, wherein a tightening torque between the first-end internally threaded segment and the adjusting bolt is greater than a tightening torque between the second-end internally threaded segment and the screwing rod.

3. The buckle-type quick release with bidirectional length adjustability of claim 2, wherein the external threaded segment of the adjusting bolt is coated with a Nylok coating.

4. The buckle-type quick release with bidirectional length adjustability of claim 1, wherein the screwing rod has the periphery further formed with a slide segment relatively close to the eccentric screwing component and a retaining flange that is located between the external threaded segment of the screwing rod and the slide segment, and the shaft has a periphery formed with at least one side via that positionally corresponds to the slide segment and is communicated with the axial hole, in which the side via receives a retaining pin that protrudes out of the axial hole, and the retaining flange can be screwedly displacement to abut against an edge of the retaining pin.

5. The buckle-type quick release with bidirectional length adjustability of claim 4, wherein the retaining pin is a countersunk screw, and the side via is a threaded hole defined by a wall that is formed with internal threads.

6. The buckle-type quick release with bidirectional length adjustability of claim 1, wherein the plug head is provided with a head socket that is open outward.

7. The buckle-type quick release with bidirectional length adjustability of claim 1, wherein the shaft has an end flange formed at the end where the second-end internally threaded segment is formed, and the channel has an inner diameter that is larger than an inner diameter of the through hole, such that a ledge is formed between the channel and the through hole and the ringlike spring has one end abutting against the end flange and an opposite end abutting against the ledge.
